(19) United States
(12) Patent Application Publication
(10) Pub. No.: US 2012/0017274 A1
(43) Pub. Date: Jan. 19, 2012

(54) WEB SCANNING SITE MAP ANNOTATION

(75) Inventor: Sven Schrecker, San Marcos, CA (US)

(73) Assignee: McAfee, Inc., Santa Clara, CA (US)

(21) Appl. No.: 12/836,941

(22) Filed: Jul. 15, 2010

(51) Int. Cl. G06F 21/00

(52) U.S. Cl. 726/22

(57) ABSTRACT

A computerized website vulnerability scanner includes a scanning module operable to navigate through a website and scan the website for vulnerabilities, and an annotation module operable to present a map of web pages comprising a part of the website. The annotation module is also operable to receive annotations from a user that are associated with the web pages, and the scanning module is further operable to use the user-provided annotations in subsequently scanning the website.

### FIELD OF THE INVENTION

The invention relates generally to computer security, and more specifically to site map annotation for web scanning.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users or criminals to attempt to communicate with other users' computers in a manner that poses a danger to the other users. For example, a hacker may attempt to log in to a corporate computer to steal, delete, or change information. Computer viruses or Trojan horse programs may be distributed to other computers, or unknowingly downloaded or executed by large numbers of computer users. Further, websites can include a variety of malicious objects, from software or scripts to media with embedded code, and are often times vulnerable to hacking from outside entities.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

For example, McAfee® Vulnerability Manager is a system that connects to a user's network, and monitors a network domain for vulnerabilities such as open ports or exposed websites. But, thoroughly scanning a single website can take hours or days to complete, making efficient and timely detection of vulnerabilities within a computer network a significant challenge.

It is therefore desirable to manage web site scanning to provide efficient detection of vulnerabilities.

### SUMMARY

Some example embodiments of the invention comprise a computerized website vulnerability scanner that includes a scanning module operable to navigate through a website and scan the website for vulnerabilities, and an annotation module operable to present a map of web pages comprising a part of the website. The annotation module is also operable to receive annotations from a user that are associated with the web pages, and the scanning module is further operable to use the user-provided annotations in subsequently scanning the website.

### BRIEF DESCRIPTION OF THE FIGURES

FIG. 1 shows a network environment, consistent with an example embodiment of the invention.

FIG. 2 shows a simplified website map, consistent with an example embodiment of the invention.

FIG. 3 shows annotations associated with website pages, consistent with an example embodiment of the invention.

FIG. 4 is a flowchart of a method of scanning a website for vulnerabilities, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

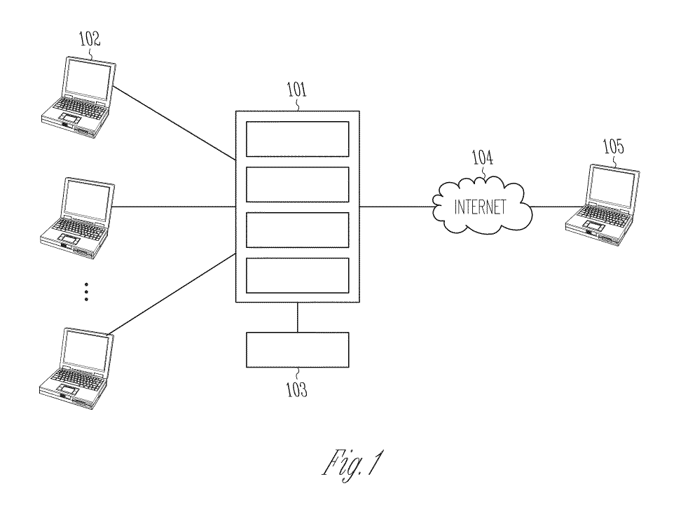

FIG. 1 illustrates a networked computing environment, consistent with an example embodiment of the invention. Here, the network includes one or more servers 101, operable to provide services such as storage, email, databases, web site hosting, and other such services to a number of computers 102 also attached to the network. This is typical of many computing environments, such as a corporation, a school, or even some homes having local area networks. A security appliance or server 103 is also shown in this example, which in various embodiments performs various functions such as a firewall or a risk management server. This network system is coupled via one or more connections to an external network such as the Internet 104, enabling the computers 102 to communicate with computers external to the local area network, such as to receive email, visit websites, and perform other such functions.

One example of an external computer system is shown at 105, which in this example represents an external computer system whose user wishes to interfere with the normal operation of the local area network computers, such as by infecting computers 102 with viruses or modifying web pages hosted on servers 101 to obtain confidential information such as customer credit card data. The owner of the local area network employs security devices represented by 103, such as a firewall designed to restrict undesired external communication from entering the local area network, and a vulnerability manager operable to evaluate the network and web site designs for flaws or vulnerabilities so that they can be addressed.

Detecting flaws in a website becomes increasingly complex as the number of pages in a website increase, the number of types of objects contained in the website increase, and the relationships between web pages and objects become more complex. For example, a simple weblog or blog having only pictures and text, where the only links to other web pages on the same web site bring you to other sequentially numbered pages of the blog, can be scanned relatively quickly and pose a very low chance of having vulnerabilities that can be exploited to steal confidential data or perform undesired functions. But, a website offering products for sale, including user accounts, product and pricing databases, shopping carts and checkout pages, and stored user data such as address and credit card information is significantly more complex, often having hundreds or thousands of pages and complex relationships between pages and web objects. There is a potential that vulnerabilities exist due to this complexity, allowing a malicious entity to gain access to information not intended by the web site administrator, author, or owner.

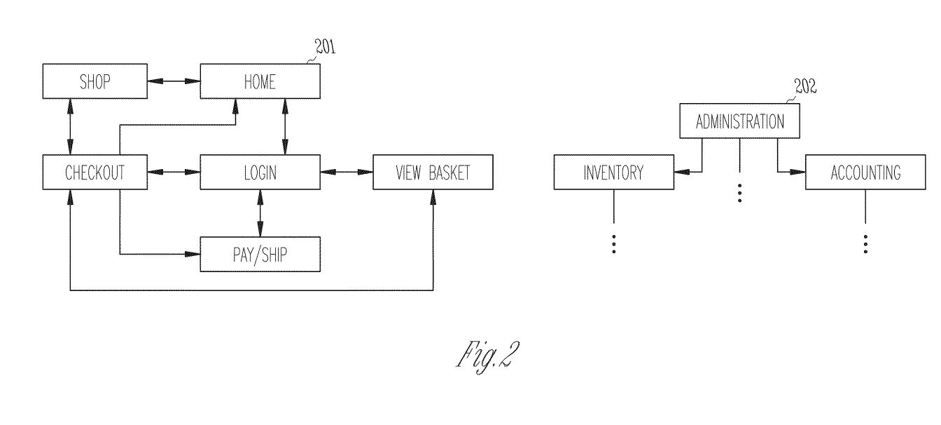

FIG. 2 is a web page site map for a simplified web merchant's website, consistent with an example embodiment of the invention. At 201, a home page enables a visitor to perform various tasks, such as proceed to a login page to log in to the website, to shop for products sold on the website, to view a shopping basket or cart of products selected for purchase, and other such functions. The relationship between these various web pages can form a complex nest of connections, where a user can browse to a large number of different pages depending on the user's current page, login state, and other such parameters. A variety of media types and other resources are accessed from various web pages, including database queries to find products, pricing, and other such information, media types to present images, sound or video promoting the items for sale, and executable scripts such as javascript programs used to provide enhanced user interaction or dynamic web pages.

A second section of the website is not evident to the user, as it is not linked to the home page and the web address of the second page must be known (or guessed) to visit. This example Administrator's site map of a different section of the website is shown at 202, and includes an administrator's home administration page as well as pages to check inventory, perform accounting, handle shipping and order fulfillment, add or delete items for sale, etc.

This example site map of FIG. 2 is greatly simplified relative to even the simplest web merchant websites, but begins to illustrate some of the problems involved with scanning a site for vulnerabilities. A variety of web objects can be found on a single site, including a variety of scripts, programs, media objects, database interfaces, and other such objects. The interrelationship between the hundreds or thousands of pages on a website can be complex, and difficult or time-consuming to determine. Some portions of the website may require logging in, such as to complete a purchase transaction, while other sections such as the administration pages may not be linked to the home page site map structure at all. All of these characteristics make effective testing of a website using a vulnerability scanner a time-consuming task that is prone to missing key areas of potential vulnerability.

Some embodiments of the invention therefore seek to provide an improved system and method for scanning a website for vulnerabilities, including scanning the website using an annotated site map to more efficiently or better scan the website for vulnerabilities. In a more detailed example, a website is first scanned using normal website scanning methods, and a website map such as that shown at 201 of FIG. 1 is produced. The website itself is made up of a number of files stored on server, sent to a requesting computer as hypertext markup language (HTML) data based on requests sent from the requesting computer's web browser. Uniform Resource Locator or URL addresses point to different portions of the website, with each page referenced by a URL typically comprising a number of files stored on the server. Site maps can therefore include the link relationships between various pages and other resources on a website, the file structure of the resources on the website, or other such logical arrangements of website resources in creating the website map.

The web pages in the website map are annotated with various notations, such as login credentials for a login page, special instructions for testing a web page's database interaction, scripts, or other special elements, or a sample account to use in testing certain web pages such as checkout, payment, and shipping pages. Annotations may also add sections of the website not found by the initial scan, such as the administration pages shown at 202. The website is then rescanned, and a more efficient or more thorough scan can be completed in less time using the annotations associated with select web pages.

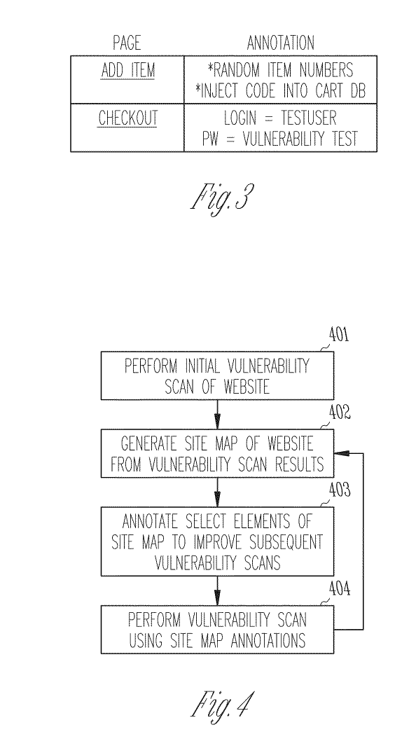

FIG. 3 shows an example of annotations associated with various web pages, consistent with an example embodiment of the invention. In the first “Add Item” web page, the annotations include instructions to test the page by replacing an item number field with random numbers, code strings, or other data in an attempt to “break” the web page or cause it to perform undesired functions. Similarly, a “Checkout” web page is annotated with a test user account name and password, so that the page's functionality and scripts can be fully tested when the vulnerability tool reaches the “Checkout” web page. Annotations in further examples include scripts or other objects missed in the web crawl, or other features of the web pages that the administrator wishes to either focus on or de-emphasize in subsequent vulnerability scans.

An annotation-assisted vulnerability scan takes advantage of an administrator's knowledge of the website's configuration and features, and can therefore provide a more thorough website scan than can reasonably be performed without such annotations. In a further example, some web pages may be trusted to a greater degree than others, such as pages that haven't changed recently, are provided by a trusted vendor, or that don't have content that interacts with a website feature that has been known to contribute to vulnerabilities. The web scanner can elect to test some pages more thoroughly than others, focusing on new content or pages having technologies known to be more susceptible to attack, better focusing the vulnerability manager's resources. This enables an administrator to perform a “surgical scan”, focusing on specific vulnerabilities or web page resources, such as to focus testing on new or suspect portions of the website.

A typical site map includes more data fields than are shown in FIG. 3, including the hierarchy of the page relative to other pages on the website, credentials used to access the page, ports used to access the page or various objects presented on the page, and vulnerabilities detected during the page scan. This information is presented to the user such as in a table format as shown in FIG. 3, a graphical map as shown in FIG. 2, or another suitable way. This enables the administrator to easily view the relationship between pages in a website, and to find particular pages. Whatever presentation method is employed, it further includes the ability to receive annotations and notes from the administrator in various embodiments of the invention, providing the administrator the ability to alter the behavior of the vulnerability manger when annotated web pages are rescanned.

Because vulnerability scans of typical real-world websites can take many hours or even days, improving the efficiency of the scan is desirable. Further, vulnerability scans of websites typically miss a variety of web page features due to the complexity of web applications and scripts, and the lack of automated tests to detect many vulnerabilities that are associated with these and other objects. Including information needed to test such web pages by way of annotations provides the vulnerability manager the ability to more thoroughly test annotated sections of the website, and to more efficiently test portions of the website that do not need such thorough testing.

Javascript and other script web pages are one example of web content that is particularly difficult to test for vulnerabilities. Annotations can be used to identify certain scripts that are newly written, haven't been previously thoroughly tested, or are targeted for more thorough evaluation for another reason. This enables more thorough scanning of some script objects, which may take hours, while other known or trusted objects are not scanned as thoroughly, improving the effectiveness and efficiency of the vulnerability scan.

The annotations in a further example may restrict activity of the vulnerability manager, such as by instructing the vulnerability manger not to interfere with a certain database in a certain undesired way, such as attempting to randomly insert new records into a medical records database. This enables the vulnerability manager to selectively perform more tests in areas of the website that may contain vulnerabilities while not performing actions that are known to cause problems. Known or existing vulnerabilities may also be tested first to determine whether they've been fixed, while the remainder of the site is tested for new vulnerabilities. This takes advantage of annotations to remember vulnerabilities across scans.

Annotations in other examples include tests that were run against a web page, vulnerabilities found, credentials needed, tests to be excluded, tests to be included, data to be injected, parameters to inject, certificates to present, protocols to use, and other such data.

FIG. 4 shows a flowchart of a method of operating a vulnerability manager, consistent with an example embodiment of the invention. At 401, a vulnerability manager performs an initial vulnerability scan of a website. A map of the website is generated at 402, reflecting the web pages, organization, and content of the website. The website map generated at 402 is annotated at 403 by a user or automated process, such as by including special testing instructions for various objects, providing login or other data for testing the web page, and identifying objects missed by the website vulnerability scan.

The annotations provide information about the pages on the website that can be used to improve the quality of future scans, such as by providing login credentials to access web pages and features not otherwise available, identifying how to test various objects, and web pages not found by the initial vulnerability scan. These annotations are used in a subsequent vulnerability scan of the website at 404, improving the efficiency of the scan. This annotation process can be repeated, as shown in FIG. 4, before the next vulnerability scan to further improve the efficiency of the scan, or the scan at 404 can be repeated with the same annotations.

The vulnerability manager is provided as a web appliance in some embodiments, such as device 103 of FIG. 1, or is incorporated into a server that performs other functions as shown at 101. Various features or functions of the manager are provided in various embodiments via hardware, software (such as software instructions stored on a machine-readable medium), user operation, or any combination thereof.

These examples illustrate how a use of administrator-provided annotations to a website map in a web vulnerability manager can be used in subsequent scans of the website to provide improved detection of vulnerabilities and faster vulnerability testing. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized website vulnerability scanner, comprising:
a scanning module operable to navigate through a website and scan the website for vulnerabilities; and
an annotation module operable to present a map of web pages comprising a part of the website and to receive annotations from a user that are associated with the web pages;
wherein the scanning module is further operable to use the user-provided annotations in subsequently scanning the website.

2. The computerized website vulnerability scanner of claim 1, wherein vulnerabilities comprise one or more of security policy noncompliance, database security, script vulnerabilities, network vulnerabilities, and application vulnerabilities.

3. The computerized website vulnerability scanner of claim 1, wherein the web page map comprises at least one of a table, a tree, and a chart.

4. The computerized website vulnerability scanner of claim 1, wherein annotations comprise at least one of web pages not found by the scanning module, objects not found by the scanning module, login credentials, and special instructions for scanning selected objects.

5. The computerized website vulnerability scanner of claim 1, wherein the scanner comprises at least one of software executed on a server, or software executed on a network appliance.

6. The computerized website vulnerability scanner of claim 1, wherein the scanning module is operable to test objects comprising executable code using at least one of static analysis in which the code is analyzed, and dynamic analysis in which the code is executed and its operation is analyzed.

7. A method of analyzing a website for vulnerabilities, comprising:
navigating through a website and scanning the website for vulnerabilities;
presenting a map of web pages comprising a part of the website receiving annotations from a user that are associated with the web pages; and
using the user-provided annotations in subsequently scanning the website for vulnerabilities.

8. The method of analyzing a website for vulnerabilities of claim 7, wherein vulnerabilities comprise one or more of security policy noncompliance, database security, script vulnerabilities, network vulnerabilities, and application vulnerabilities.

9. The method of analyzing a website for vulnerabilities of claim 7, wherein the web page map comprises at least one of a table, a tree, and a chart.

10. The method of analyzing a website for vulnerabilities of claim 7, wherein annotations comprise at least one of web pages not found by the scanning module, objects not found by the scanning module, login credentials, and special instructions for scanning selected objects.

11. The method of analyzing a website for vulnerabilities of claim 7, wherein the scanner comprises at least one of software executed on a server, and a network appliance.

12. The method of analyzing a website for vulnerabilities of claim 7, wherein scanning the website for vulnerabilities comprises testing objects comprising executable code using at least one of static analysis in which the code is analyzed, and dynamic analysis in which the code is executed and its operation is analyzed.

13. A machine-readable medium with instructions stored thereon, the instructions when executed operable to cause a computerized system to:
navigate through a website and scanning the website for vulnerabilities;
present a map of web pages comprising a part of the website receive annotations from a user that are associated with the web pages; and
use the user-provided annotations in subsequently scanning the website for vulnerabilities.

14. The machine-readable medium of claim 13, wherein vulnerabilities comprise one or more of security policy noncompliance, database security, script vulnerabilities, network vulnerabilities, and application vulnerabilities.

15. The machine-readable medium of claim 13, wherein the web page map comprises at least one of a table, a tree, and a chart.

16. The machine-readable medium of claim 13, wherein annotations comprise at least one of web pages not found by the scanning module, objects not found by the scanning module, login credentials, and special instructions for scanning selected objects.

17. The machine-readable medium of claim 13, wherein the scanner comprises at least one of software executed on a server, and a network appliance.

18. The machine-readable medium of claim 13, wherein scanning the website for vulnerabilities comprises testing objects comprising executable code using at least one of static analysis in which the code is analyzed, and dynamic analysis in which the code is executed and its operation is analyzed.
